(19) United States
(12) Patent Application Publication
(10) Pub. No.: US 2016/0307137 A1
(43) Pub. Date: Oct. 20, 2016

(54) MANAGING TECHNOLOGY ELEMENTS AND ASSOCIATED OBLIGATIONS

(71) Applicant: Bank of America Corporation, Charlotte, NC (US)

(72) Inventors: Ellen S. Adams, Belmont, NC (US); Heather J. Hagan, Charlotte, NC (US); James A. Blanchard, III, Midland, NC (US)

(21) Appl. No.: 14/687,585

(22) Filed: Apr. 15, 2015

(51) Int. Cl. G06Q 10/06; G06Q 30/00

(52) U.S. Cl. CPC G06Q 10/06315; G06Q 30/018

(57) ABSTRACT

In certain embodiments, a system for managing an inventory of obligations comprises a database configured to store associations between obligations, technology elements, and contacts related to the obligations and the technology elements. The system further comprises an interface operable to receive an identification of a first obligation and a processor operable to identify a first technology element and a first contact, wherein the first technology element and the first contact are associated with the first obligation and the interface is further operable to receive an indication of a modification to the first technology element. The processor is further operable to generate a notification comprising the indicated modification and a feedback request regarding the feasibility of implementing the indicated modification. The interface is further operable to communicate the notification and the feedback request to the first contact and to receive a response to the communicated feedback request.

### TECHNICAL FIELD

This disclosure relates generally to obligations associated with technology elements, and more particularly to identifying and maintaining associations between technology elements and obligations.

### BACKGROUND

An enterprise may rely on technology elements to comply with particular obligations, for example, various statutes, regulations, and enterprise policies. However, enterprise technology elements may be interconnected with other enterprise technology elements and the relationships between various technology elements, and between obligations and complying technology elements, can be difficult to discern. Moreover, when there are changes to an obligation, or there are new obligations, it is often difficult for an enterprise to identify related technology elements and to verify compliance of the related technology elements with the new or changed obligations. Similarly, it is often difficult for an enterprise to modify technology components due to the potential impact on compliance with related obligations and the impact to related technology elements.

### SUMMARY OF EXAMPLE EMBODIMENTS

According to embodiments of the present disclosure, disadvantages and problems associated with verifying compliance of technology elements with enterprise obligations may be reduced or eliminated.

In certain embodiments, a system for managing technology elements and associated obligations includes a memory comprising a database. The database is configured to store associations between a plurality of obligations, a plurality of technology elements, and a plurality of contacts related to the plurality of obligations and the plurality of technology elements. An interface is communicatively coupled to the memory and operable to receive an identification of a first obligation from the plurality of obligations. A processor is communicatively coupled to the memory and the interface and operable to identify a first technology element from the plurality of technology elements, wherein the first technology element is associated with the first obligation. The processor is further operable to identify a first contact from the plurality of contacts, wherein the first contact is associated with the first technology element and the first obligation. The interface is further operable to receive an indication of a modification to the first technology element. The processor is further operable to generate a notification comprising the indicated modification and generate a request for feedback regarding the feasibility of implementing the indicated modification. The interface is further operable to communicate the notification and the request for feedback to the first contact and receive a response to the communicated request for feedback. The processor is further operable to calculate, based on the received response to the communicated request for feedback, at least one from a set comprising: a time estimate to implement the indicated modification and a cost estimate to implement the indicated modification.

Certain embodiments of the present disclosure may provide one or more technical advantages having specific technical effects.

In an embodiment, associations between technology elements and related obligations are identified, thereby conserving the computational resources and bandwidth consumed by supporting duplicative technology elements for particular obligations.

In certain embodiments, feedback requests for time estimates are generated to contacts associated with particular technology elements, thereby reducing the computational resources and bandwidth consumed by generating and communicating unnecessary feedback requests.

In another embodiment, feedback requests for time estimates to perform modifications to technology elements are pre-populated with standardized reporting scales, thereby conserving the computational resources and bandwidth consumed normalizing received time estimates.

In yet another embodiment, feedback requests for cost estimates to perform modifications to technology elements are pre-populated with standardized reporting scales, thereby conserving the computational resources and bandwidth consumed normalizing received cost estimates

Other technical advantages of the present disclosure will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present disclosure and for further features and advantages thereof, reference is now made to the following description taken in conjunction with the accompanying drawings, in which:

FIG. 1 illustrates an example embodiment of a system for managing technology elements and associated obligations, according to certain embodiments of the present disclosure;

FIG. 2 illustrates a table of database fields that may be used in an example embodiment of managing technology elements and associated obligations, according to certain embodiments of the present disclosure; and

FIG. 3 illustrates a flow diagram of an example method for managing technology elements and associated obligations, according to certain embodiments of the present disclosure.

### DETAILED DESCRIPTION

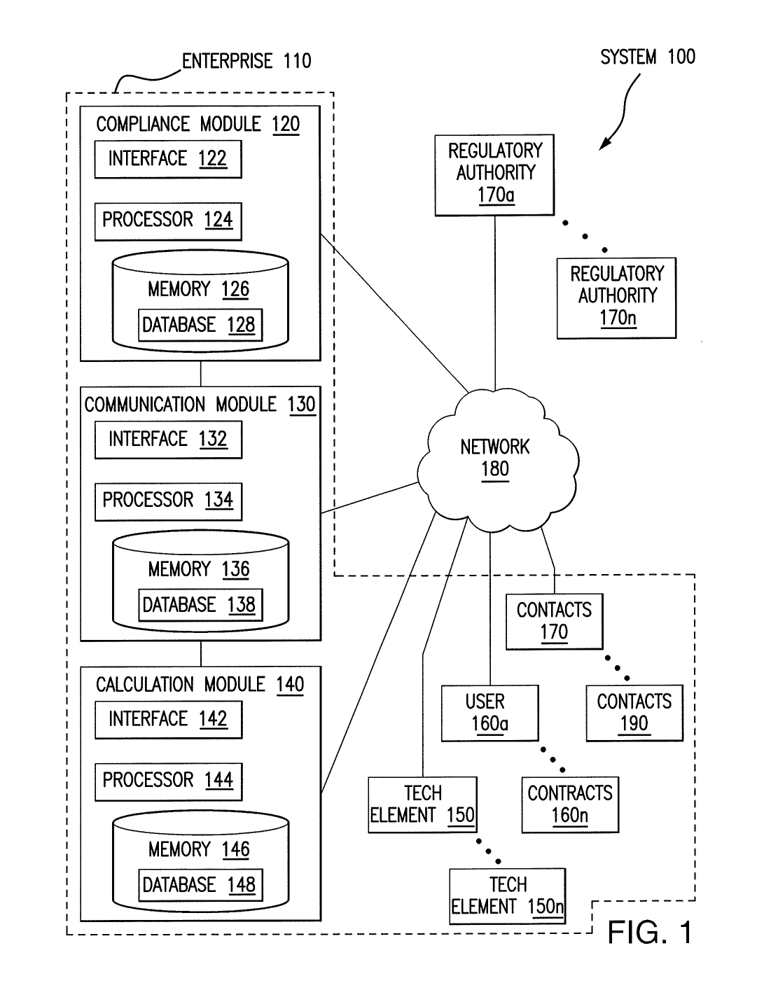

Embodiments of the present disclosure and its advantages are best understood by referring to FIGS. 1, 2, and 3 of the drawings, like numerals being used for like and corresponding parts of the various drawings.

In an example embodiment of the present disclosure, an enterprise maintains a database of relationships between technology elements utilized by the enterprise (e.g., electronic hardware and software applications) and obligations (e.g., statutes, regulations, and enterprise policies) applicable to the enterprise. The database may further include relationships between technology elements and/or obligations and between contacts associated with the technology elements and/or obligations. Contacts may represent enterprise employees responsible for ensuring compliance with particular obligations or employees responsible for managing particular technology elements.

Users may access the database to determine obligations, technology elements, and/or contacts associated with other obligations, technology elements, and/or contacts. For example, a statute applicable to the enterprise may change and a user (e.g., a compliance officer) may need to know other obligations (e.g., regulations and/or enterprise policies) related to the changed statute, technology elements configured to comply with the changed statute, and contacts associated with both the obligations and technology elements associated with the changed statute.

The changed statute may require a modification to particular technology elements to ensure compliance with the change statute. A user may identify a modification to a technology element and generate a message, for example a feedback request, to a contact associated with the technology element in need of modification. In certain embodiments, requests for feedback include requests for time estimates to implement a modification, cost estimates to implement a modification, difficulty estimates to implement a modification, or any suitable information. Feedback requests may include pre-populated information, such as selectable options from a standardized scale of cost, time, or other suitable metric. In an embodiment, contacts may respond to feedback requests with feedback responses containing the requested information, such as by selecting options from the pre-populated scales. A system may be operable to include feedback responses in calculations (e.g., time, cost, or other suitable calculation) related to implementing a modification to a technology element.

Similarly, a user may need to modify or replace a technology element and may utilize the database to identify associated technology elements (e.g., associated hardware and/or software applications), applicable obligations (e.g., statutes, regulations, and enterprise policies), and contacts associated with the associated technology elements and applicable obligations. In an embodiment, a user may identify a modification to a technology element to contacts for associated technology elements and/or applicable obligations and request feedback from the contacts regarding the impact of the modification to the technology element. For example, a user may request confirmation that the modification complies with applicable obligations and/or that the modification does not negatively impact associated technology elements.

Accordingly, enterprises may effectively manage relationships between obligations, technology elements, and responsible contacts and efficiently manage changes to obligations and/or modifications to technology elements.

FIG. 1 illustrates an example embodiment of a system 100 for managing technology elements 150 and associated obligations, according to certain embodiments of the present disclosure. According to an embodiment, system 100 includes enterprise 110, network 180, and regulatory authorities 170. Enterprise 110 may include compliance module 120, communication module 130, calculation module 140, technology elements 150, users 160, and contacts 190.

Enterprise 110 represents an entity that maintains and/or operates compliance module 120, communication module 130, calculation module 140, and technology elements 150. Enterprise 110 may be any suitable type of business entity. In certain embodiments, enterprise 110 has different business units or subdivisions that handle different business activities. Different subdivisions of enterprise 110 may maintain and/or operate one or more of compliance module 120, communication module 130, calculation module 140, and/or technology elements 150. In particular embodiments, enterprise 110 may include organizations such as commercial banks, savings and loan associations, credit unions, Internet banks, mutual fund companies, insurance companies, brokerage firms, credit card companies, or other provider of electronic transaction services.

Compliance module 120 represents a component of system 100 operable to store and manage a database (e.g., database 128) of associations between obligations for enterprise 110 and related technology elements 150. In certain embodiments, compliance module 120 includes interface 122, processor 124, memory 126, and database 128. Database 128 of compliance module 120 may further store associations between obligations, technology elements 150, and contacts 190 related to the obligations and/or technology elements 150. In certain embodiments, compliance module 120 is operable to identify obligations, technology elements 150, and/or contacts 190 associated with particular obligations, technology elements 150, and/or contacts 190. For example, if an obligation, such as a statute, changed, compliance module 120 may identify other obligations related to the changed statute (e.g., regulations or enterprise 110 policies), technology elements 150 related to the changed statute (e.g., applications and/or hardware complying with aspects of the changed statute), and/or contacts 190 responsible for the obligations and/or technology elements 150 for enterprise 110. Similarly, if a technology element 150 needs to be modified, compliance module 120 may identify obligations related to the modified technology element 150, other technology elements 150 related to the modified technology element 150, and contacts 190 for the identified obligations and/or technology elements 150. Accordingly, compliance module 120 allows enterprise 110 to ensure compliance with governing obligations, to efficiently manage compliance with those obligations when modifying technology elements 150 and/or responding to new or changed obligations.

Communication module 130 represents a component of system 100 operable to manage communications (e.g., notifications, messages, feedback requests, feedback responses, or any other suitable communication) for enterprise 110. In certain embodiments, communication module 130 includes interface 132, processor 134, memory 136, and database 138. Communication module 130 may maintain contact information (e.g., phone numbers, e-mail addresses, mailing addresses, office location, etc.) for contacts 190. In certain embodiments, communication module 130 generates and communicates messages to contacts 190. Messages may include notifications, requests for feedback, feedback responses, or any other suitable message. A request for feedback (or feedback request) may represent a message to contacts 190 requesting feedback about an issue, such as modifications to technology elements 150, new or changing obligations associated with technology elements 150, or any other suitable issue related to obligations associated with technology elements 150. Contacts 190 may respond to feedback requests with feedback responses.

In particular embodiments, messages include pre-populated information. Pre-populated information may include text, images, selectable options, or any other suitable information. In certain embodiments, pre-populated information includes selectable options on a standardized scale that represents time, cost, difficulty, or other metric. For example, a message may be a request for feedback that includes a scale of cost from 1, representing a low cost, to 10, representing a high cost, that includes 1, 2, 3, 4, 5, 6, 7, 8, 9, and 10 as selectable options. In another example, a message may identify a modification to one or more technology components 150 and provide selectable options regarding whether the modification complies with particular obligations associated with the one or more technology components. Contacts 190 may respond to feedback requests with feedback responses that include the requested feedback information (e.g., selecting an option from the pre-populated scale). Accordingly, communication module 130 may provide enterprise 110 with normalized feedback regarding modifications to technology elements 110 and/or new or changed obligations.

In an example, if an obligation for enterprise 110 changed, communication module 130 may generate a feedback request for contacts 190 associated with technology elements 150 affected by the obligation change. In certain embodiments, the requested feedback may include a time estimate to implement a modification to technology elements 150, a cost estimate to implement a modification to technology elements 150, an estimated schedule to implement a modification to technology elements 150, a verification of compliance of a modification to technology elements 150 with associated obligations, or any other suitable information related to the feasibility of the identified modification. For example, a feedback request may identify a modification to one or more technology elements 150 related to an obligation change, and request feedback from contacts 190 associated with the one or more technology elements 150 regarding the feasibility of implementing the modification. Similarly, if there is a modification to a particular technology element 150, communication module 130 may generate a feedback request to contacts 190 for associated obligations requesting feedback related to whether the modification complies with the associated obligations. For example, if a piece of hardware, such as a server, was being modified, communication module 130 may generate and send feedback requests to contacts 190 for obligations associated with the server requesting feedback on whether the modification complies with the associated obligations. Contacts 190 may respond to feedback requests with feedback responses that include the requested information.

Calculation module 140 represents a component of system 100 operable to perform calculations related to modifications to technology elements 150 and/or new or changed obligations. In certain embodiments, calculation module 140 includes interface 142, processor 144, memory 146, and database 148. Calculations may include cost estimates, time estimates, difficulty estimates, or any other suitable calculation. In certain embodiments, calculations are performed based on feedback responses to feedback requests. For example, a feedback request may include a pre-populated selectable scale of a cost estimate for a modification to a particular technology element 150. Contacts 190 may respond to the feedback request by selecting a cost estimate from the feedback request. Calculation module 140 may determine a cost estimate for the modification based, at least in part, on the received feedback responses, but may rely on any suitable criteria for calculations.

Technology elements 150 represent electronic hardware and or software (e.g., applications) utilized by enterprise 110. Technology elements 150 may be configured to comply with particular obligations of enterprise 110. For example, a regulation may require a particular encryption level for monetary transactions and technology elements 150 supporting monetary transactions may ensure the required encryption level is used for the monetary transactions.

Users 160 represent entities that access system 100. Users 160 may include businesses or other commercial organizations, government agencies, individuals, or any other suitable user. In certain embodiments, users 160 access system 100, which may include accessing compliance module 120, communication module 130, and calculation module 140. Users 160 may also be contacts 190 for particular obligations and/or technology elements 150.

Regulatory authorities 170 represent any entity with regulatory authority over enterprise 110. In certain embodiments, regulatory authorities 170 promulgate rules (e.g., obligations) applicable to enterprise 110 and which may be complied, at least in part, through technology elements 150 utilized by enterprise 110. In certain embodiments, regulatory authorities 170 include trade associations, governments, government agencies, or other body that may have regulatory authority over enterprise 110. Regulatory authorities 170 may require compliance with certain obligations. In certain embodiments, regulatory authorities 170 may perform audits or investigations and may order certain compliance measures.

Contacts 190 represent entities (e.g., individuals or groups) associated with (e.g., responsible for) obligations and/or technology elements 150 within enterprise 110. For example, enterprise 110 may employ individuals to ensure that enterprise 110 complies with state and federal statutes and regulations (e.g., obligations). An individual (e.g., a compliance officer) may be responsible for ensuring enterprise 110 complies with one or more obligations. Similarly, enterprise 110 may employ individuals to manage technology elements 150 (e.g., hardware or software applications). In particular embodiments, contacts 190 may include users 160.

Network 180 represents any suitable network operable to facilitate communication between elements of system 100, such as enterprise 110, compliance module 120, communication module 130, calculation module 140, users 160, and regulatory authorities 180. Network 180 may include any interconnecting system capable of transmitting audio, video, electrical signals, optical signals, data, messages, or any combination of the preceding. Network 180 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the elements of system 100.

A module (e.g., modules 120, 130, and 140) may execute any suitable operating system such as IBM's zSeries/Operating System (z/OS), MS-DOS, PC-DOS, MAC-OS, WINDOWS, a .NET environment, UNIX, OpenVMS, or any other appropriate operating system, including future operating systems. The functions of a module may be performed by any suitable combination of one or more servers or other elements at one or more locations. In embodiments where modules represent a server, the server may be a private server, and the server may be a virtual or physical server. Additionally, a module may include any suitable element that functions as a server.

Components of system 100, such as compliance module 120, communication module 130, and calculation module 140, may include one or more processors. A processor represents any computing device, such as processors 124, 134, and 144, configured to control the operation of one or more components of system 100. A processor may comprise one or more processors and may be a programmable logic device, a microcontroller, a microprocessor, any suitable processing device, or any suitable combination of the preceding. In certain embodiments, a processor represents an application specific, as opposed to general purpose, circuit such as an application specific integrated circuit (“ASIC”). A processor may include any hardware or software that operates to control and process information received by a component of system 100. In certain embodiments, a processor communicatively couples to other components of system 100, such as a module (e.g., modules 120, 130, and 140), an interface (e.g., interfaces 122, 132, and 142), a memory (e.g., memories 126, 136, and 146), a database (e.g., databases 128 and 138), or any other suitable component.

An interface represents any device, such as interfaces 122, 132, and 142 operable to receive input, send output, process the input or output, or perform other suitable operations for a component of system 100. An interface includes any port or connection, real or virtual, including any suitable hardware or software, including protocol conversion and data processing capabilities, to communicate through network 180. In certain embodiments, an interface includes a user interface (e.g., physical input, graphical user interface (“GUI”), touchscreen, buttons, switches, transducer, or any other suitable method to receive input from a user).

A memory represents any device, such as memories 126, 136, and 146 operable to store, either permanently or temporarily, data, operational software, or other information for a processor. Memory includes any one or a combination of volatile or non-volatile local or remote devices suitable for storing information. For example, a memory may include random access memory (RAM), read only memory (ROM), magnetic storage devices, optical storage devices, semiconductor storage devices, or any other suitable information storage device or a combination of these devices. A memory may include any suitable information for use in the operation of component of system 100. A memory may further include some or all of one or more databases (e.g., databases 128, 138, and 148).

Logic may perform the operation of any component of system 100, for example, logic executes instructions to generate output from input. Logic may include hardware, software, or other logic. Logic may be encoded in one or more non-transitory, tangible media, such as a computer-readable medium or any other suitable tangible medium, and may perform operations when executed by a computer or processor. Certain logic, such as a processor, may manage the operation of a component.

In certain embodiments, compliance module 120 is operable to store database 128 in memory 126. Database 128 may store relationships between obligations (e.g., state and/or federal statutes, state and/or federal regulations, and/or enterprise 110 policies) and technology elements 150 (e.g., applications and/or hardware). Database 128 may be further operable to store contacts 190 (e.g., obligation and/or technology element 150 owners) related to the obligations or to technology elements 150. For example, if a first contact 190 is responsible for (e.g., owns) a first technology element 150, database 128 may store the association between the first contact 190 and the first technology element 150.

Interface 122 of compliance module 120 may be operable to receive an identification of an obligation (e.g., a statute). The obligation may be a new obligation or a changed obligation. For example, interface 122 of compliance module 120 may receive a change to a regulation that requires all new accounts opened by enterprise 110 to include an account owner's Social Security number. In this example, memory 126 stores the changed obligation in database 128. Processor 124 of compliance module 120 is operable to identify which other obligations and/or technology elements 150 are associated with the changed obligation. In an embodiment, processor 124 identifies an association between the changed obligation and the first technology element 150, and processor 124 further identifies an association between the first technology element 150 and the first contact 190.

Communication module 130 facilitates communication between the components of system 100. In an embodiment, interface 132 of communication module 130 may receive an indication of a modification to technology component 150. For example, interface 132 may receive an indication that the first technology element 150 does not comply with the changed obligation and may further receive a modification to the first technology element 150 to come into compliance with the changed obligation. Processor 134 of communication module 130 may then generate a notification indicating that the first technology element 150 fails to comply with the changed obligation. In an example, processor 134 also generates a request for feedback regarding the level of difficulty involved with implementing the identified modification to the first technology element 150. Interface 132 of communication module 130 communicates the notification that the first technology element 150 does not comply with the new obligation, and the request for feedback to the first contact 190 associated with the first technology element 150. Interface 132 is further operable to receive the feedback response from the first contact 190. Communication module 130 may continuously or periodically monitor database 138 for changes.

While this example includes one obligation and one technology element 150, other examples may include multiple obligations and/or multiple technology elements 150. Similarly, while this example includes one contact 190, one notification, and one feedback request, other examples may include several or no contacts 190, notifications, and/or feedback requests.

A request for feedback (e.g., generated by processor 134 of communication module 130) may include selectable pre-populated reporting criteria. For example, the selectable pre-populated reporting criteria may include a scale representing a time estimate to implement the modification to the first technology element 150 and selectable options may include a number of different time estimate ranges. The selectable pre-populated reporting criteria may also include a scale representing a cost estimate to implement the modification to the first technology element 150. The pre-populated reporting criteria may further include other suitable scales. For example, a scale representing a time or cost estimate may include other scales, such as the time or cost required to update marketing materials and/or the time or cost required to provide training related to the modification to the first technology element 150.

Memory 136 of communication module 130 may be operable to store database 138. In some embodiments, database 138 stores new or changed obligations. Similarly, database 138 may be operable to store new technology elements 150 or changed technology elements 150. For example, database 138 may store modifications to technology element 150 to bring technology element 150 into compliance with a changed obligation. In some embodiments, database 138 of communication module 130 and database 128 of compliance module 120 may be the same database.

Calculation module 140 may be operable to calculate the feasibility of implementing changes to obligations and/or technology elements 150. For example, processor 144 of calculation module 140 may calculate the estimated time required to implement the indicated modifications to technology element 150 to bring technology element 150 into compliance with a new or changed obligation. In another example, processor 144 of calculation module 140 may calculate an estimated cost required to implement the indicated modifications to technology element 150 to bring it into compliance with a new or changed obligation.

In other embodiments, interface 122 of compliance module 120 may be operable to receive an identification of a technology element 150 (e.g., hardware). The technology element 150 may be a new technology element 150 or a changed technology element 150. For example, interface 122 of compliance module 120 may receive a first technology element 150, such as a new piece of hardware. In this example, memory 126 stores the first technology element 150 in database 128. Processor 124 of compliance module 120 is operable to identify which other technology elements 150 and/or obligations are associated with the first technology element 150. In this embodiment, processor 124 identifies an association between the first technology element 150 and a second technology element 150, such as a software application, and processor 124 further identifies an association between the second technology element 150 and a second contact 190. In addition, processor 124 may identify an association between the second technology element 150 and an obligation.

Interface 132 of communication module 130 may receive an indication of a modification to a technology element 150. For example, interface 132 may receive an indication that a new technology element 150 is not in compliance with an obligation (e.g., a statute). Processor 134 of communication module 130 may generate a notification indicating that the new technology element 150 fails to comply with the obligation. In this example, processor 134 also generates a request for feedback regarding the level of difficulty involved with bringing the new technology element 150 into compliance with the obligation. Interface 132 of communication module 130 communicates the notification of the new technology element 150 failing to comply with the obligation and the request for feedback to contact 190 associated with the new technology element 150. Interface 132 is further operable to receive the feedback request from the associated contact 190.

In another example, interface 122 of compliance module 120 may receive an indication of that a technology element 150 is being replaced (e.g., a server). Processor 124 of compliance module 120 is operable to identify other technology elements 150 and/or obligations are associated with the technology element 150 being replaced. In this embodiment, processor 124 identifies an association between the technology element 150 and a related technology element 150 (e.g., a software application), and processor 124 further identifies an association between the related technology element 150 and a contact 190. In addition, processor 124 identifies an association between the related technology element 150 and an obligation.

In this example, interface 132 of communication module 130 receives an indication that replacing technology element 150 will bring the related technology element 150 out of compliance with an obligation. Processor 134 of communication module 130 may then generate a notification indicating the compliance issue to associated contacts 190. Processor 134 also generates a request for feedback regarding the level of difficulty involved with bringing the related technology element 150 into compliance with the obligation. Interface 132 of communication module 130 communicates the notification and the request for feedback to associated contacts 190. Interface 132 is further operable to receive the feedback responses from associated contacts 190.

Modifications, additions, or omissions may be made to system 100. System 100 may include more, fewer, or other components. Any suitable component of system 100 may include a processor, interface, logic, memory, or other suitable element.

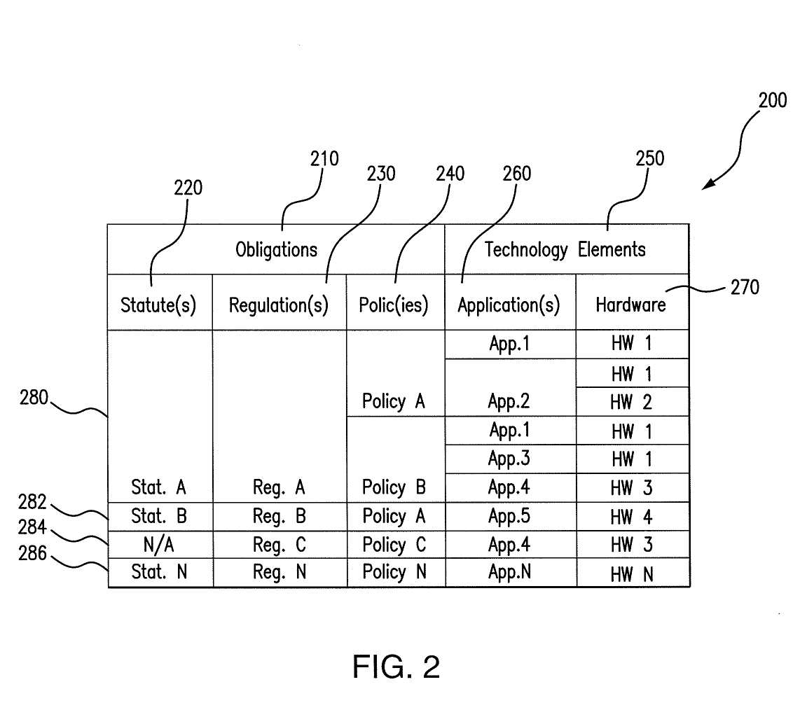

FIG. 2 illustrates a table of database fields that may be used in an example embodiment to manage technology elements 150 and associated obligations, according to certain embodiments of the present disclosure. In the illustrated embodiment, table 200 includes obligations heading 210 and technology elements heading 250. Obligations heading 210 includes requirements for enterprise 110 that may relate to technology elements 150. Obligations heading 210 may include state and/or federal statutes, state and/or federal regulations, industry best practices, policies of enterprise 110, or any other requirement associated with enterprise 110. In the illustrated embodiment, obligations heading 210 includes statutes field 220, regulations field 230, and policies field 240.

Statutes field 220 represents state and/or federal statutes applicable to enterprise 110. In the illustrated embodiment, statutes field 220 includes one or more statutes 220 that may be associated with technology elements (e.g., applications 260 and/or hardware 270) and/or other obligations 250 (e.g., regulations and/or policies).

Regulations field 230 represents state and/or federal regulations applicable to enterprise 110. In certain embodiments, regulations field 230 includes one or more regulations that may be associated with technology elements 150 and/or other obligations (e.g., statutes and/or policies).

Policies field 240 represents enterprise 110 policies and may include one or more policies that may be associated with technology elements 150 and/or other obligations (e.g., statutes and/or regulations). Policies field 240 may include rules and/or guidelines developed by enterprise 110 (e.g., company policy, industry best practice, etc.). In certain embodiments, policies may exist, at least in part, to comply with obligations such as statutes and/or regulations.

Technology elements heading 250 represents electronic hardware and/or software (e.g., software applications) utilized by enterprise 110. In certain embodiments, technology elements 150 are configured to comply with obligations (e.g., statutes, regulations, and/or policies) applicable to enterprise 110. While technology elements heading 250 in the illustrated embodiment includes applications field 260 and hardware field 270, technology elements heading 250 may instead or in addition include any suitable technology element 150 for use in table 200.

Applications field 260 includes one or more applications that may be associated with obligations and/or other technology elements 150 (e.g., hardware and/or other applications). Applications may represent programs and/or instructions used to run a system and may include software, products, services, processes, or forms. Hardware field 270 includes electronic hardware utilized by enterprise 110. Hardware may be associated with obligations and/or other technology elements 150 (e.g., applications). Hardware may represent the physical components of a computer or other electronic system and can include servers, networking equipment, encryption equipment,) equipment, mobile devices, work stations or any other suitable electronic hardware.

Rows 280, 282, 284, and 286 illustrate example embodiments of values for the fields of table 200. In one example, row 280 depicts “Stat. A” in statute field 220, “Reg. A” in regulation field 230, “Policy A” and “Policy B” of policy field 240, “App. 1,” “App. 2,” “App. 3,” and “App. 4” of application field 260, and “HW 1,” “HW 2,” and “HW 3” of hardware field 270. In the illustrated embodiment, row 280 is an example of four obligations (Stat. A, Reg. A, Policy A, and Policy B) that are associated with each other. For example, Policy A and Policy B may be enterprise 110 policies to comply with portions of Reg. A which was promulgated under Stat. A. In addition, row 280 shows the association between four obligations (Stat. A, Reg. A, Policy A, and Policy B) and seven technology elements 150 (App. 1, App. 2, App. 3, App. 4, HW 1, HW 2, and HW 3).

In the illustrated embodiment, row 280 shows that Reg. A is associated with Policy A and Policy B; Policy A is associated with App. 1 and App. 2, App. 1 is associated with HW 1, and App. 2 is associated with HW 1 and HW 2. Similarly, Policy B is associated with App. 1, App. 3, and App. 4. For example, App. 1 and App. 2 may comply with elements of Policy A and run on HW 1 and HW 2. In the event that Reg. A was changed, users 160 of system 100 would be able to identify that Policy A and Policy B may need to be modified to comply with changed Reg. A, and that App. 1, App. 2, App. 3, App. 4, HW 1 and HW 2 may also need to be modified as they too relate to Reg. A. Similarly, if App. 2 needed to be modified, users 160 would be able to identify HW 2, Policy A, Reg. A, and Stat. A as related obligations and technology elements 150 associated with App. 2. Users 160 may coordinate with contacts 190 for the associated obligations and technology elements 150, who may also be identified in table 200, to determine the impact of the modification to App. 2.

In another example, row 282 includes “Stat. B” in statute field 220, “Reg. B” in regulation field 230, “Policy A” in policy field 240, “App. 5” in application field 260, and “HW 4” in hardware field 270. In table 200, row 282 is an example of three obligations (Stat. B, Reg. B, and Policy A) that are associated with each other. In addition, row 282 shows the association between three obligations (Stat. B, Reg. B, and Policy A) and two technology elements (App. 5 and HW 4).

In a yet another example, row 284 includes “Reg. C” in regulation field 230, “Policy C” in policy field 240, “App. 4” in application field 260, and “HW 3” in hardware field 270. Row 284 is an example of two obligations (Reg. C and Policy C) that are associated with each other. In addition, row 284 shows the association between two obligations (Reg. C and Policy C) and two technology elements 150 (App. 4 and HW 3). In this example, Reg. C and Policy C of row 284 are not associated with a statute from statute field 220.

In a further example, row 286 includes “Reg. N” of regulation field 230, “Policy N” of policy field 240, “App. N” of application field 260, and “HW N” of hardware field 270, where N represents any suitable number. Row 286 illustrates that table 200 may include any suitable number of values in statute field 220, regulation field 230, policies field 240, applications field 260, and/or hardware field 270. While obligations heading 210 includes three obligations in row 286, other embodiments may include any suitable number of obligations 210, statutes 220, regulations 230, policies 240, technology elements 250, applications 260, and/or hardware 270.

Further, while the illustrated embodiment of table 200 includes two headings (obligations heading 210 and technology elements heading 250), other embodiments may include one or more headings. For example, table 200 may include obligations heading 210, technology elements heading 250, and a contacts heading. Similarly, while the illustrated embodiment of table 200 includes two fields under technology elements 250, other embodiments may include more or fewer fields.

Modifications, additions, or omissions may be made to table 200. Table 200 may include more or less fields, and may include any information relevant to obligations and technology components. Table 200 may include any suitable amount of information and may be stored in any suitable type or number of memories.

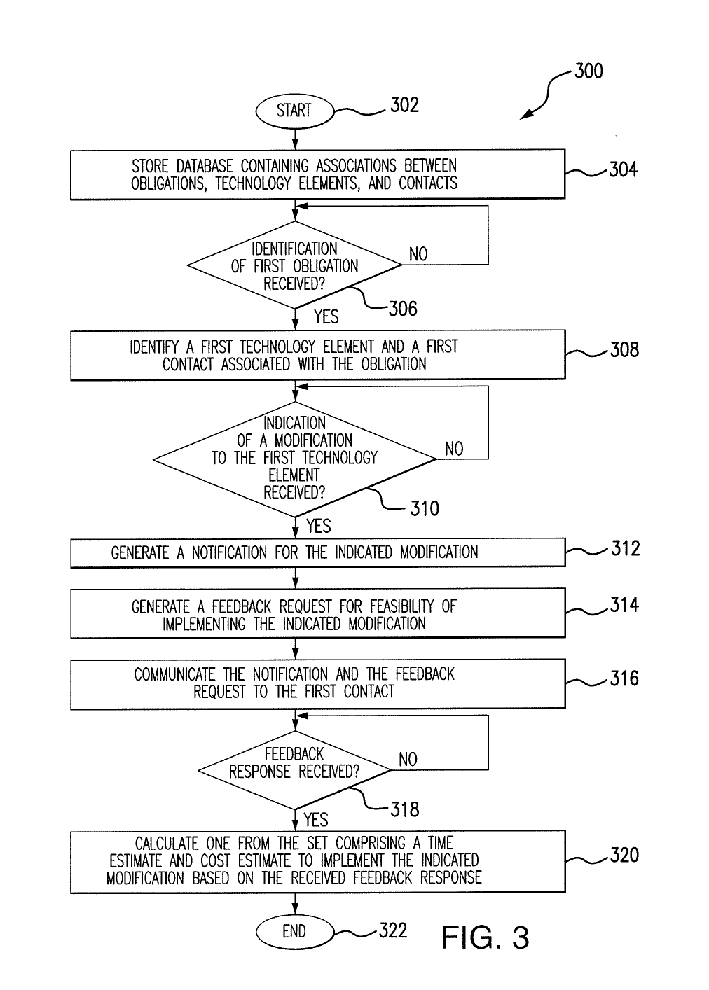

FIG. 3 illustrates a flow diagram of an example method for managing technology elements 150 and associated obligations, according to certain embodiments of the present disclosure. Method 300 begins at step 302. At step 304, a memory (e.g., memory 126 or memory 136) stores a database (e.g., database 128 or database 138). The database may store associations between a plurality of obligations, a plurality of technology elements 150, and a plurality of contacts 190. In certain embodiments, the database may include one or more contacts 190 associated with technology elements 150 and/or obligations. At Step 306, it is determined whether an interface (e.g., interface 122) has received an identification of a first obligation. If an identification of a first obligation has not been received, the method returns to step 306. If an identification has been received, the method continues to step 308.

At step 308, a first technology element 150 associated with the first obligation is identified. In an embodiment, contacts 190 associated with the first technology element and/or the first obligation are identified. The method then moves to step 310. At Step 310, it is determined whether an indication of a modification to the first technology element 150 has been received (e.g., by interface 122). If no indication of a modification to the first technology element 150 has been received, the method returns to step 310. If an indication has been received, the method continues to step 312. At step 312, a notification is generated comprising the indicated modification (e.g., by processor 134). The method continues to step 314, where a request for feedback regarding the feasibility of implementing the indicated modification is generated (e.g., by processor 134). At step 316, the notification and the request for feedback are communicated to the first contact 190 (e.g., by interface 132). In certain embodiments, either the notification or the request for feedback may be communicated. In particular embodiments, a notification and/or a request for feedback may be generated on a periodic or continuous basis. For example, processor 134 may generate a notification to contact 190 periodically, once every minute, once a week, or three times a week. As another example, processor 134 may update the notification in real time so that contact 190 can check technology element 150 compliance with obligations at any given time. At step 318, it is determined whether a feedback response to the communicated request for feedback has been received. If no feedback response has been received, the method returns to step 318. If a feedback response has been received, the method continues to step 320, a time estimate and/or a cost estimate to implement the indicated modification based on the received feedback response is calculated (e.g., by processor 144). The method ends at step 322.

Modifications, additions, or omissions may be made to method 300. The method may include more, fewer, or other steps. Additionally, steps may be performed in any suitable order, in parallel, and/or sequentially. Any suitable component of may perform one or more steps of method 300.

Certain embodiments of the present disclosure may provide one or more technical advantages having specific technical effects.

In an embodiment, associations between technology elements and related obligations are identified, thereby conserving the computational resources and bandwidth consumed by supporting duplicative technology elements for particular obligations.

In certain embodiments, feedback requests for time estimates are generated to contacts associated with particular technology elements, thereby reducing the computational resources and bandwidth consumed by generating and communicating unnecessary feedback requests.

In another embodiment, feedback requests for time estimates to perform modifications to technology elements are pre-populated with standardized reporting scales, thereby conserving the computational resources and bandwidth consumed normalizing received time estimates.

In yet another embodiment, feedback requests for cost estimates to perform modifications to technology elements are pre-populated with standardized reporting scales, thereby conserving the computational resources and bandwidth consumed normalizing received cost estimates

Other technical advantages of the present disclosure will be readily apparent to one skilled in the art from the following figures, descriptions, and claims. Moreover, while specific advantages have been enumerated above, various embodiments may include all, some, or none of the enumerated advantages.

What is claimed is:

1. A system, comprising:
a memory comprising a database, the database configured to store associations between a plurality of obligations, a plurality of technology elements, and a plurality of contacts related to the plurality of obligations and the plurality of technology elements;
an interface communicatively coupled to the memory and operable to receive an identification of a first obligation from the plurality of obligations;
a processor communicatively coupled to the memory and the interface and operable to:
identify a first technology element from the plurality of technology elements, wherein the first technology element is associated with the first obligation;
identify a first contact from the plurality of contacts, wherein the first contact is associated with the first technology element and the first obligation;
the interface further operable to receive an indication of a modification to the first technology element;
the processor further operable to:
generate a notification comprising the indicated modification; and
generate a request for feedback regarding the feasibility of implementing the indicated modification;
the interface further operable to:
communicate the notification and the request for feedback to the first contact; and
receive a response to the communicated request for feedback; and
the processor further operable to calculate, based on the received response to the communicated request for feedback, at least one from a set comprising: a time estimate to implement the indicated modification and a cost estimate to implement the indicated modification.

2. The system of claim 1, wherein the indicated modification to the first technology element is related to a deficiency in the first technology element based on the first obligation.

3. The system of claim 1, wherein the first obligation is associated with one or more technology elements from the plurality of technology elements, wherein the one or more technology elements include at least one from a set comprising: electronic hardware and software.

4. The system of claim 1, wherein the request for feedback includes selectable pre-populated reporting criteria.

5. The system of claim 4, wherein the selectable pre-populated reporting criteria includes at least one from a set comprising: a selectable indication on a scale representing a time estimate to implement the indicated modification and a selectable indication on a scale representing a cost estimate to implement the indicated modification.

6. The system of claim 1, the interface further operable to receive an identification of a second technology element; and
the processor further operable to:
identify a third technology element associated with the second technology element, wherein the third technology element is from the plurality of technology elements;
identify a second obligation associated with the second technology element, wherein the second obligation is from the plurality of obligations; and
identify a second contact from the plurality of contacts, wherein the second contact is associated with at least one from a set comprising: the second technology element, the third technology element, and the second obligation, wherein the identification of the second contact includes contact information for the second contact.

7. The system of claim 1, wherein the first obligation is one from a set comprising: a new obligation and a changed obligation.

8. A non-transitory computer readable storage medium comprising logic operable to:
store a database, the database configured to store associations between a plurality of obligations, a plurality of technology elements, and a plurality of contacts related to the plurality of obligations and the plurality of technology elements;
receive an identification of a first obligation from the plurality of obligations;
identify a first technology element from the plurality of technology elements, wherein the first technology element is associated with the first obligation;
identify a first contact from the plurality of contacts, wherein the first contact is associated with the first technology element and the first obligation;
receive an indication of a modification to the first technology element;
generate a notification comprising the indicated modification;
generate a request for feedback regarding the feasibility of implementing the indicated modification;
communicate the notification and the request for feedback to the first contact; and
receive a response to the communicated request for feedback; and
calculate, based on the received response to the communicated request for feedback, at least one from a set comprising: a time estimate to implement the indicated modification and a cost estimate to implement the indicated modification.

9. The computer readable storage medium of claim 8, wherein the indicated modification to the first technology element is related to a deficiency in the first technology element based on the first obligation.

10. The computer readable storage medium of claim 8, wherein the first obligation is associated with one or more technology elements from the plurality of technology elements, wherein the one or more technology elements include at least one from a set comprising: electronic hardware and software.

11. The computer readable storage medium of claim 8, wherein the request for feedback includes selectable pre-populated reporting criteria.

12. The computer readable storage medium of claim 11, wherein the selectable pre-populated reporting criteria includes at least one from a set comprising: a selectable indication on a scale representing a time estimate to implement the indicated modification and a selectable indication on a scale representing a cost estimate to implement the indicated modification.

13. The computer readable storage medium of claim 8, the interface further operable to receive an identification of a second technology element; and
the processor further operable to:
identify a third technology element associated with the second technology element, wherein the third technology element is from the plurality of technology elements;
identify a second obligation associated with the second technology element, wherein the second obligation is from the plurality of obligations; and
identify a second contact from the plurality of contacts, wherein the second contact is associated with at least one from a set comprising: the second technology element, the third technology element, and the second obligation, wherein the identification of the second contact includes contact information for the second contact.

14. The computer readable storage medium of claim 8, wherein the first obligation is one from a set comprising: a new obligation and a changed obligation.

15. A method, comprising:
storing, by a memory, a database, the database configured to store associations between a plurality of obligations, a plurality of technology elements, and a plurality of contacts related to the plurality of obligations and the plurality of technology elements;
receiving, by an interface, an identification of a first obligation from the plurality of obligations;
identifying, by a processor, a first technology element from the plurality of technology elements, wherein the first technology element is associated with the first obligation;
identifying, by a processor, a first contact from the plurality of contacts, wherein the first contact is associated with the first technology element and the first obligation;
receiving, by the interface, an indication of a modification to the first technology element;
generating, by the processor, a notification comprising the indicated modification; and
generating, by the processor, a request for feedback regarding the feasibility of implementing the indicated modification;
communicating, by the interface, the notification and the request for feedback to the first contact; and
receiving, by the interface, a response to the communicated request for feedback; and
calculating, by the processor and based on the received response to the communicated request for feedback, at least one from a set comprising: a time estimate to implement the indicated modification and a cost estimate to implement the indicated modification.

16. The method of claim 15, wherein the indicated modification to the first technology element is related to a deficiency in the first technology element based on the first obligation.

17. The method of claim 15, wherein the first obligation is associated with one or more technology elements from the plurality of technology elements, wherein the one or more technology elements include at least one from a set comprising: electronic hardware and software.

18. The method of claim 15, wherein the request for feedback includes selectable pre-populated reporting criteria.

19. The method of claim 18, wherein the selectable pre-populated reporting criteria includes at least one from a set comprising: a selectable indication on a scale representing a time estimate to implement the indicated modification and a selectable indication on a scale representing a cost estimate to implement the indicated modification.

20. The method of claim 15, further comprising:
receiving, by the interface, an identification of a second technology element;
identifying, by the processor, a third technology element associated with the second technology element, wherein the third technology element is from the plurality of technology elements;
identifying, by the processor, a second obligation associated with the second technology element, wherein the second obligation is from the plurality of obligations; and
identifying, by the processor, a second contact from the plurality of contacts, wherein the second contact is associated with at least one from a set comprising: the second technology element, the third technology element, and the second obligation, wherein the identification of the second contact includes contact information for the second contact.
